(19) United States
(12) Patent Application Publication
(10) Pub. No.: US 2009/0290255 A1
(43) Pub. Date: Nov. 26, 2009

(54) METHOD OF MANUFACTURING MAGNETIC RECORDING MEDIA, MAGNETIC RECORDING MEDIA AND MAGNETIC READ/WRITE DEVICE

(75) Inventor: Akira Sakawaki, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/064,905

(22) PCT Filed: Nov. 7, 2006
(86) PCT No.: PCT/JP2006/322520

§ 371 Date: Feb. 26, 2008

Related U.S. Application Data
(60) Provisional application No. 60/738,599, filed on Nov. 22, 2005.

(30) Foreign Application Priority Data
Nov. 11, 2005 (JP) 2005-327414
Feb. 23, 2006 (JP) 2006-046291

(51) Int. Cl. G11B 5/127; G11B 5/84; G11B 5/66

(52) U.S. Cl. 360/110; 427/130; 428/834; G9B/5.104

(57) ABSTRACT

A manufacturing method which is capable of easily and inexpensively manufacturing discrete track-type magnetic recording media is provided.

A method of manufacturing magnetic recording media having a main surface on which magnetic tracks 4 are disposed in a substantially concentric arrangement and on which grooves 5 for magnetically separating radially adjoining magnetic tracks 4 from one another are formed is characterized by forming on a flat substrate 1 at least a magnetic recording layer 2 so as to fabricate a workpiece 1a, then pressing a stamper having protrusions corresponding to the grooves 5 against a main surface of the workpiece so as to transfer the shape of the protrusions to the workpiece and form grooves 5 between the magnetic tracks 4.

Priority is claimed on Japanese Patent Application No. 2005-327414, filed Nov. 11, 2005, Japanese Patent Application No. 2006-046291, filed Feb. 23, 2006, and U.S. Provisional Patent Application No. 60/738,599, filed Nov. 22, 2005, the contents of which are incorporated herein by reference.

### TECHNICAL FIELD

The present invention relates to a method of manufacturing magnetic recording media, magnetic recording media, and a magnetic read/write device.

### BACKGROUND ART

In recent years, with magnetic recording media such as hard disks used in external storage devices for computers being called on to store increasing amounts of information, there has arisen a need to further increase the density of signals recorded per unit surface area. To achieve such an improvement in the surface recording density, it is necessary to increase either or both the linear recording density and the track recording density.

One effective method for improving the linear recording density that has recently been proposed is a so-called perpendicular magnetic recording method which carries out recording with a single-pole head using a perpendicular magnetic recording medium having a CoCr alloy-based magnetic recording layer with magnetic anisotropy in the vertical direction of the substrate and having a soft magnetic layer of permalloy or the like.

An effective method that has been proposed for improving the track recording density is a method which uses a discrete track-type magnetic recording medium having magnetically decoupled magnetic tracks to avoid the generation of fringing noise during read and write operations.

Two different methods have been proposed for manufacturing such discrete track-type magnetic recording media. One involves etching away part of a magnetic layer formed on a flat substrate (e.g., see Patent Document 1). In the other, a magnetic layer is formed on a substrate in which raised and recessed features have been formed beforehand in signal recording areas by a technique such as injection molding (e.g., see Patent Document 2).

Patent Document 1: JP-A 4-310621

Patent Document 2: JP-A 9-54946

### DISCLOSURE OF INVENTION

In the former method, because a magnetic layer is not present in recessed areas, the recorded data is magnetically separated and a signal-to-noise ratio sufficient for positioning with a servo can be obtained, However, shortening the dry etching time for removing the magnetic layer is difficult. Moreover, exactly the required amount of only the magnetic layer must be precisely removed from unnecessary areas, making it difficult to set and control the etching conditions. Such circumstances render this approach unsuitable for use as an ordinary mass production process that must provide a good yield.

As for the latter method, aside from using a substrate in which raised and recessed features have been formed, the same medium manufacturing process can be employed as in the prior art, making this approach suitable for mass production. However, because the magnetic layer remains in recessed areas, magnetic separation of the recorded data is weak. Moreover, the signal-to-noise ratio of servo signals is small, making it impossible to properly position the head.

Patent Document 2 thus proposes a method for magnetization in opposite directions between recessed and raised areas. However, because formatting with the magnetic head is required, the advantages of a discrete track-type magnetic recording medium, which aims to reduce costs by eliminating servo write operations, are greatly compromised. Moreover, a large height difference is required between the recessed areas and the raised areas, thus lowering the flying stability of the head. Also, due to the increased track density, the raised and recessed features have a higher aspect ratio, making the substrate more difficult to shape and narrowing further the width of the recessed areas. When a magnetic recording layer is formed on top of such a substrate, it ends up obstructing the recessed areas. In such cases, new problems arise, including the formation of defects such as peeling and cracking of the magnetic recording layer, and interference with the head.

The present invention was conceived in order to resolve the above drawbacks of the prior art. Therefore, one object of the present invention is to provide a manufacturing method which is capable of easily manufacturing discrete track-type magnetic recording media at low cost. Another object of the invention is to provide such magnetic recording media. A further object is to provide a magnetic read/write device.

Accordingly, the invention provides the following.

(1) A method of manufacturing magnetic recording media having a main surface on which magnetic tracks are disposed in a substantially concentric arrangement and on which grooves for magnetically separating radially adjoining magnetic tracks from one another are formed, the method being characterized by forming on a flat substrate at least a magnetic recording layer so as to fabricate a workpiece, then pressing a stamper having protrusions corresponding to the grooves against a main surface of the workpiece so as to transfer the shape of the protrusions to the workpiece and form grooves between the magnetic tracks.
(2) The method of manufacturing magnetic recording media according to (1) above which is characterized in that protrusions have a tip with a curved surface which satisfies the relationship 0.75 W≦R≦1.25 W, where R is the radius of curvature of the curved surface and W is the width of the protrusions.
(3) The method of manufacturing magnetic recording media according to (1) or (2) above which is characterized in that the grooves have a depth of from 50 to 100 nm.
(4) The method of manufacturing magnetic recording media according to any one of (1) to (3) above which is characterized by fabricating a workpiece in which the magnetic recording layer is formed on the substrate and a protective layer is formed on the magnetic recording layer, then pressing the stamper against the main surface of the workpiece.
(5) The method of manufacturing magnetic recording media according to any one of (1) to (3) which is characterized by pressing the stamper against the main surface of the workpiece, then forming a protective layer on the magnetic recording layer.
(6) The method of manufacturing magnetic recording media according to any one of (1) to (5) above which is characterized by pressing the stamper against the workpiece until the shape of the protrusions is transferred to the substrate.
(7) The method of manufacturing magnetic recording media according to any one of (1) to (6) which is characterized by pressing the stamper against the workpiece until the thickness of the magnetic recording layer becomes thinner at the bottom of the grooves.
(8) The method of manufacturing magnetic recording media according to any one of (1) to (6) which is characterized by pressing the stamper against the workpiece until the magnetic recording layer is severed at the bottom of the grooves.
(9) The method of manufacturing magnetic recording media according to any one of (1) to (8) which is characterized in that the magnetic recording layer has perpendicular magnetic anisotropy.
(10) The method of manufacturing magnetic recording media according to any one of (1) to (9) which is characterized by placing an orientation layer between the substrate and the magnetic recording layer.
(11) The method of manufacturing magnetic recording media according to (10) above which is characterized by placing a soft magnetic layer between the substrate and the orientation layer.
(12) The method of manufacturing magnetic recording media according to any one of (1) to (11) above which is characterized in that the substrate is made of a material selected from among plastic, glass, and aluminum alloy.
(13) A magnetic recording medium having a main surface on which magnetic tracks are disposed in a substantially concentric arrangement and on which grooves for magnetically separating radially adjoining magnetic tracks from one another are formed, the medium being characterized in that a substrate in which grooves have been formed has formed thereon at least a magnetic recording layer and, over the magnetic recording layer, a protective layer, and the magnetic recording layer has a smaller thickness or is severed at the bottom of the grooves.
(14) The magnetic recording medium of (13) above which is characterized in that the bottom of the grooves has a curved surface which satisfies the relationship 0.75 W′≦R′≦1.25 W′, where R′ is the radius of curvature of the curved surface and W′ is the width of the grooves.
(15) The magnetic recording medium of (13), wherein the magnetic recording layer at the bottom of the grooves has a thickness of 2 nm or less.
(16) A magnetic read/write device comprising a magnetic recording medium and a magnetic head which writes magnetic signals to and reads magnetic signals from the magnetic recording medium, the magnetic read/write device being characterized in that the magnetic head is a single-pole magnetic head and the magnetic recording medium is the magnetic recording medium of above (13) or (14).

As described above, the present invention can form magnetic tracks to a higher density without resorting to complex, difficult-to-control microfabrication such as dry etching, and thus enables discrete track-type magnetic recording media having excellent magnetic properties suitable for higher recording densities to be easily and inexpensively manufactured.

### BRIEF DESCRIPTION OF THE DRAWINGS

FIG. 1 is a schematic sectional view showing the structure of a magnetic recording medium according to the invention.

FIG. 2 presents schematic sectional views illustrating steps in the manufacture of the magnetic recording medium shown in FIG. 1.

FIG. 3 is a schematic front view of a stamper.

FIG. 4 is an enlarged front view of a protrusion on the stamper.

FIG. 5 presents schematic sectional views illustrating steps in the fabrication of a stamper.

FIG. 6 is a schematic sectional view showing a construction in which an orientation layer is disposed on the magnetic recording medium.

FIG. 7 is a schematic sectional view showing a construction in which a soft magnetic layer is disposed on the magnetic recording medium.

FIG. 8 is a graph of the track pitch versus the servo signal intensity ratio.

FIG. 9 is a graph of the track pitch versus the error rate.

FIG. 10 is a graph of the groove depth versus the servo signal intensity ratio.

FIG. 11 is a graph of the groove depth versus the frequency of fabrication defects.

FIG. 12 is a graph of the track pitch versus the error rate ratio.

FIG. 13 is a graph of the magnetic recording layer thickness at the bottom of the grooves versus the error rate ratio.

### BEST MODE FOR CARRYING OUT THE INVENTION

The method of manufacturing magnetic recording media, the magnetic recording media and the magnetic read/write device according to the present invention are described in detail below in conjunction with the accompanying diagrams. In the diagrams referred to in the description below, for the sake of convenience key features are sometimes shown enlarged so that their characteristics will be more readily understood, but the relative dimensions of the respective elements shown in the diagrams may differ from reality.

### Magnetic Recording Medium

First, the magnetic recording medium according to the invention is described.

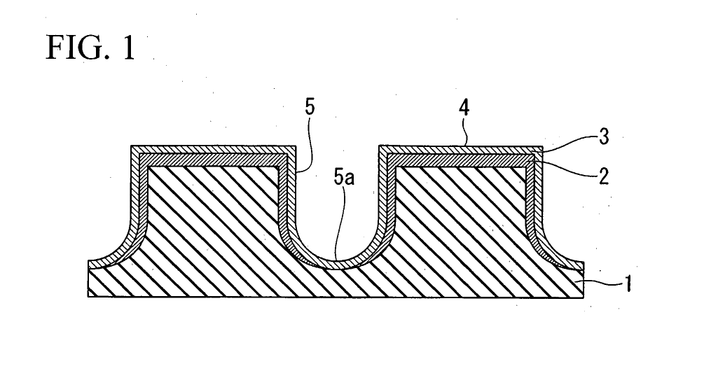

Referring to FIG. 1, the magnetic recording media according to the invention are discrete track-type magnetic recording media (magnetic disks) which can be used in magnetic read/write devices such as a hard disk drives (HDD), and are composed of at least a disk substrate 1, a magnetic recording layer 2 formed on the disk substrate 1, and a protective layer 3 formed on the magnetic recording layer 2.

This magnetic recording medium has a main surface on which are disposed magnetic tracks 4 in a substantially concentric arrangement and on which are formed grooves 5 for magnetically separating radially adjoining magnetic tracks 4 from one another.

The bottom 5a of the grooves 5 has a curved surface which satisfies the relationship 0.75 W′≦R′≦1.25 W′, where R′ is the radius of curvature of the curved surface and W′ is the width of the grooves. R′≈R and W′≈W; that is, R′ is substantially the same as R, and W′ is substantially the same as W.

The disk substrate 1 is a nonmagnetic substrate made of, for example, plastic, glass or an aluminum alloy. The magnetic recording layer 2 and the protective layer 3 are successively deposited on the disk substrate 1 by sputtering or the like.

The magnetic recording layer 2 is, for example, a magnetic film having perpendicular magnetic anisotropy. A ferromagnetic material for which the axis of easy magnetization is oriented primarily in a direction perpendicular to the main surface of the disk substrate 1 is used as this magnetic recording layer 2. The ferromagnetic material is preferably one having a magnetic anisotropic energy of at least 1×10⁵ erg/cc. Illustrative examples of such ferromagnetic materials include alloys containing cobalt and platinum, such as CoPt and CoCrPt, and alloys containing iron and platinum, such as FePt. In addition, an oxide such as SiO₂, Cr₂O₃, ZrO₂, Al₂O₃ and Ta₂O₅ may be added to these ferromagnetic materials. The magnetic recording layer 2 may be composed of a plurality of magnetic materials of differing compositions such as Co/Pt or Co/Pd that are formed as successive layers, or may be composed of a magnetic material and a nonmagnetic material that are formed as successive layers.

The magnetic recording layer 2 has a thickness of preferably 5 to 30 nm. By setting the thickness of this magnetic recording layer 2 to 5 nm or more, a sufficient magnetic flux can be achieved and a high signal-to-noise ratio is obtained when reading data, enabling a magnetic recording medium that is better suited for high recording densities to be obtained. On the other hand, by setting the thickness of this magnetic recording layer 2 to 30 nm or less, the magnetic recording layer 2 can be expelled from the bottom 5a of the subsequently described grooves 5 during formation of the grooves 5. Moreover, an increase in noise due to enlargement of the magnetic particles within the magnetic recording layer 2 can be suppressed, enabling deterioration of the read/write characteristics to be prevented.

The protective layer 3 protects the magnetic recording layer 2 from corrosion and prevents damage to the surface of the magnetic recording medium when the magnetic head come into contact with the medium. Conventionally well-known materials can be used for the magnetic recording layer 3. Illustrative examples of the protective layer 3 preferably include ones composed of carbon or containing a substance such as SiO₂ or ZrO₂. The protective layer 3 has a thickness of preferably 1 to 5 nm. Setting the thickness of this protective layer 3 in a range of 1 to 5 nm provides the protective layer with a sufficient durability and allows the gap between the magnetic head and the magnetic recording layer 2 to be reduced, making it possible to achieve higher recording densities.

The magnetic recording medium 1 of the invention is characterized in that a disk substrate 1 in which the above-described grooves 5 have been formed has formed thereon at least a magnetic recording layer 2 and, over the magnetic recording layer 2, a protective layer 3, and in that the magnetic recording layer 2 has a smaller thickness or is severed at the bottom 5a of the grooves 5.

### Method of Manufacturing Magnetic Recording Media

Next, the method of manufacturing magnetic recording media according to the invention is described.

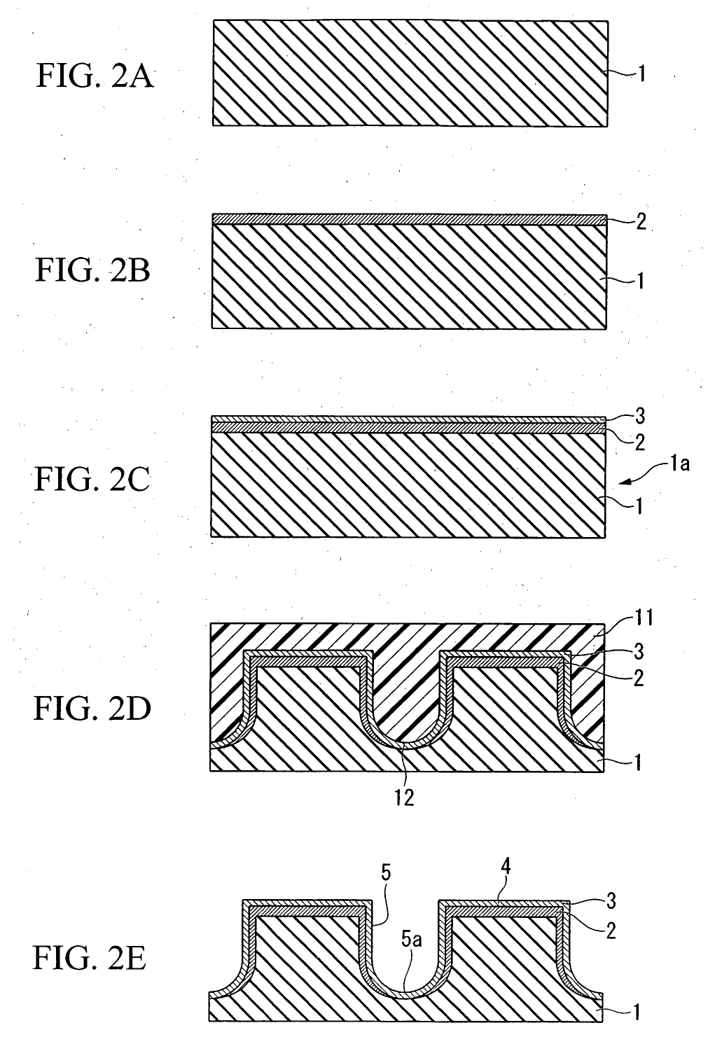

FIG. 2 presents schematic cross-sectional views illustrating steps in the manufacture of the above-described magnetic recording medium shown in FIG. 1.

As shown in FIG. 2, the inventive method of manufacturing magnetic recording media is characterized by forming on a flat disk substrate 1 at least a magnetic recording layer 2 so as to fabricate a workpiece 1a, then pressing a stamper 11 having protrusions 12 corresponding to the grooves 5 against a main surface of the workpiece 1a so as to transfer the shape of the protrusions 12 to the workpiece and form grooves 5 between the magnetic tracks 4.

Specifically, when the above-described magnetic recording medium shown in FIG. 1 is manufactured, as shown in FIG. 2A, first a disk substrate 1 which has been shaped and finished at the main surface to a mirror-like surface is provided.

Next, as shown in FIG. 2B, a magnetic recording layer 2 is formed by sputtering on the disk substrate 1 having a planarized main surface.

Then, as shown in FIG. 2C, a protective layer 3 is formed by sputtering on the magnetic recording layer 2.

This provides a workpiece 1a composed of the disk substrate 1 on which the magnetic recording layer 2 and the protective layer 3 have been successively deposited.

Next, as shown in FIG. 2D, a stamper 11 is pressed against the main surface of the fabricated workpiece 1a by an imprinting method.

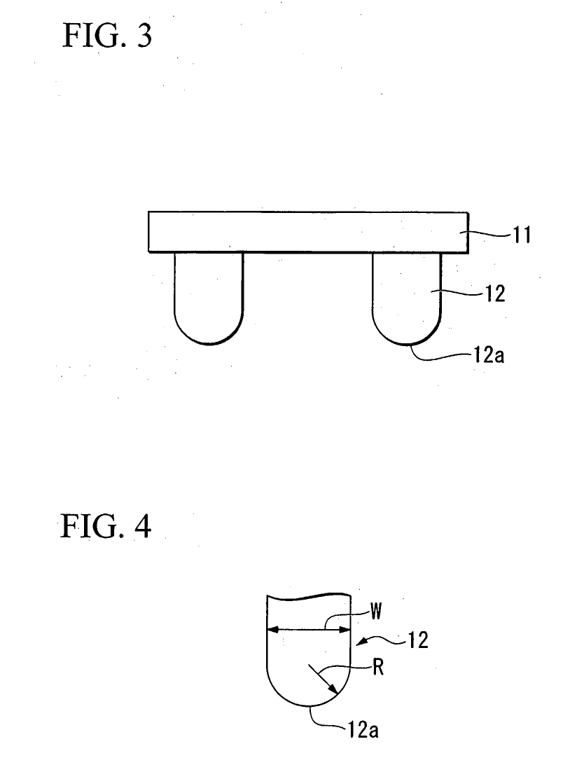

Referring to FIG. 3, this stamper 11 has, on the surface that comes into contact with the workpiece 1a, protrusions 12 which correspond to the shape of the grooves 5 that are actually to be formed on the workpiece 1a. As shown enlarged in FIG. 4, these protrusions 12 serve as negative patterns for the grooves 5 and thus have tips 12a which, instead of being square, have curved surfaces that are rounded.

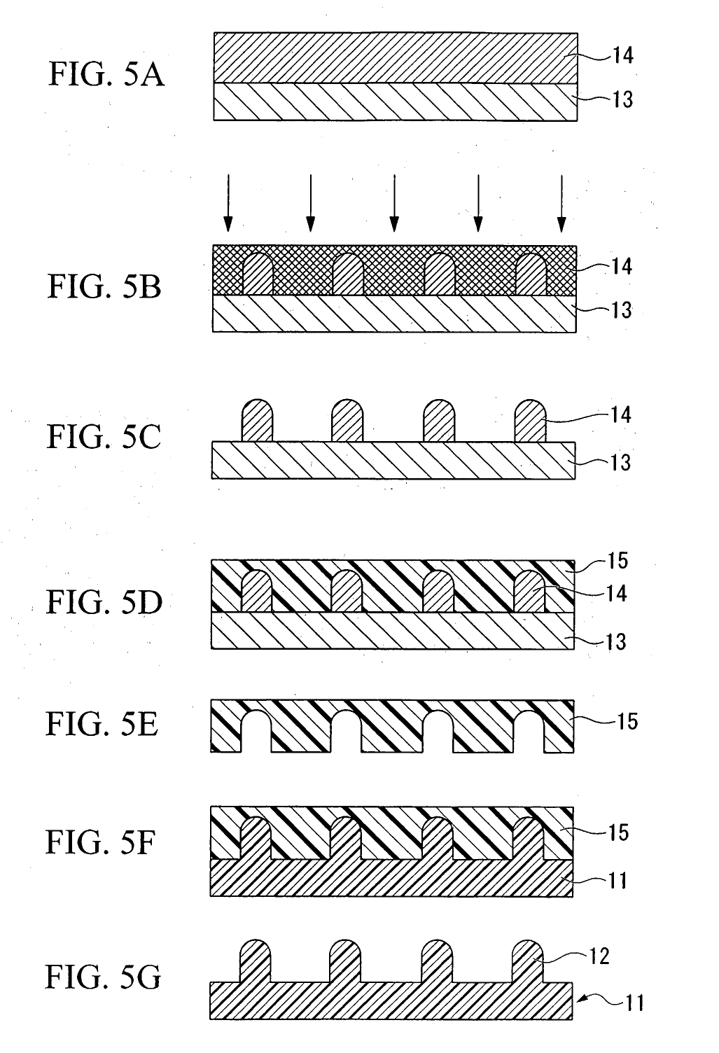

The stamper 11 having such protrusions 12 can be fabricated by a process involving steps like those shown in FIG. 5. First, a positive resist layer 14 is formed on a substrate 13 made of a material such as silicon (a). Next, the resist layer 14 is subjected to double exposure (b) by carrying out ordinary electron beam radiation at places where the recessed areas of the stamper 11 will be located, followed by lower-power, broader-width electron beam radiation that exposes only the surface layer portion of the resist layer 14. The resist layer 14 is then removed by development (c), following which the surface is treated to make it electrically conductive and a first nickel electroforming operation is carried out (d), thereby forming a plating layer 15 on the substrate 13. Next, this plating layer 15 is removed from the substrate 13 (e). The surface of the removed plating layer 15 is then oxidized with an oxygen plasma, after which it is treated to make it electrically conductive and a second nickel electroforming operation is carried out (f). Finally, the plating layer 15 is removed, giving the stamper 11 (g).

Next, as shown in FIG. 2D, such a stamper 11 and the workpiece 1a are laminated together, then placed on a stage (not shown), where the stamper 11 is pressed against the main surface of the workpiece 1a under the application of pressure by a piston.

At this time, the stamper 11 and the workpiece 1a are heated to and held at or above the shape-retaining temperature of the disk substrate 1. In the practice of the invention, a nonmagnetic substrate made of, for example, plastic, glass or an aluminum alloy is used as the disk substrate 1, and imprinting of the particular material is carried out at the shape-retaining temperature or more. That is, to transfer the shape of the protrusions 12 to the disk substrate 1, the stamper 11 is pressed against the workpiece 1a until deformation due to the transfer of this protrusion 12 reaches the surface layer of the disk substrate 1.

When glass is used as the disk substrate 1, the heating temperature will be higher than for plastic. In such a case, to prevent deterioration of the magnetic recording layer 2 and the like, it is preferable to carry out pattern transfer in an inert atmosphere.

Next, as shown in FIG. 2E, the stamper 11 is separated from the workpiece 1a, thus forming grooves 5 as the transferred shape of the protrusions 12 between the magnetic tracks 4. Lastly, a perfluorinated lubricant layer is formed, thereby giving a magnetic recording medium according to the invention.

As noted above, the invention enables higher density magnetic tracks 4 to be formed without resorting to a complex and difficult-to-control microfabrication technique such as dry etching, thus making it possible to easily and inexpensively manufacture discrete track-type magnetic recording medium having excellent magnetic characteristics which are more suitable for a high recording density.

As shown in FIG. 4, it is advantageous for the protrusions 12 on the stamper 11 to have tips 12a with a curved surface which satisfies the relationship 0.75 W≦R≦1.25 W, where R is the radius of curvature of the curved surface and W is the width of the protrusion.

Thus, during transfer of the protrusion 12 shapes, pressing the protrusions of the stamper 11 against the main surface of the workpiece 1a laterally expels, due to plastic deformation, the respective layers of the workpiece 1a positioned at the bottom 5a of the grooves 5 formed by transfer. As a result, the magnetic recording layer at the bottom 5a of these grooves 5 either has a smaller thickness or is severed.

However, when R<0.75 W, flat areas form at the tips 12a of the protrusions 12, so that lateral expulsion of the respective layers of the workpiece 1a is inadequate. On the other hand, when R>12.5, the tips 12a of the protrusions 12 have an acutely angled shape which makes the shape prone to deterioration with repeated use of the stamper 11 and thus shortens the useful life (number of repeated uses it can endure) of the stamper 11. The resulting rise in the frequency of replacement lowers productivity, and the increase in the number of stampers required increases production costs.

Also, it is preferable for the grooves 5 to have a depth of 50 nm or more. By having such a depth, the magnetic recording layer 2 positioned at the bottom 5a of the grooves 5 can be fully expelled at the time of transfer. In addition, by setting the height difference between the raised and recessed surface features on the main surface of the magnetic recording medium in a range of 50 to 100 nm, stable head flying characteristics can be ensured.

When the grooves 5 have a depth of less than 50 nm, expulsion of the magnetic recording layer positioned in the bottom 5a of the grooves 5 is inadequate. If magnetic recording layer 2 having anisotropy in a direction perpendicular to the substrate remains at the bottom 5a of the grooves, noise will be generated during data read and write operations or a sufficient signal-to-noise ratio will not be obtained due to a decrease in the output of the servo signals. On the other hand, at a groove 5 depth of more than 100 nm, the head clearance will vary in regions where the surface area of the raised features is small (e.g., servo regions) and in regions where the surface area of the raised features is large (e.g., data regions), making stable data read and write operations impossible to carry out.

It is preferable for the magnetic recording layer 2 at the bottom 5a of the grooves 5 to have a thickness of 2 nm or less, and preferably 1 nm or less. By setting the thickness to 2 nm or less, magnetization of the magnetic recording layer 2 at the bottom 5a of the grooves becomes smaller. Moreover, with the bottom 5a of the grooves 5 curved in the shape of the tips 12a on the stamper protrusions, the orientation of the magnetic recording layer 2 with respect to the substrate deviates from a perpendicular direction, making it possible to better eliminate noise during data read/write due to magnetization of the magnetic recording layer 2 at the bottom of the grooves 5, a decrease in the servo signal output, and deterioration in the error rate due to fringing. At a thickness of more than 2 nm, magnetic anisotropy will remain in the direction perpendicular to the substrate at the bottom 5a of the grooves, giving rise to noise generation during data read/write, a decrease in the servo signal output, and a deterioration in the error rate due to fringing.

It is preferable for the heating temperature during transfer to be set to at least the above-mentioned shape-retaining temperature of the substrate material but below the melting point. Setting the temperature within this range makes it is possible for deformation due to transfer of the raised areas 12 to reach the surface layer of the disk substrate 1. This allows damage such as deformation or collapse of the transfer pattern to be suppressed, in addition to which it enables a sufficient pattern height difference to be achieved, enabling a distinct and faithful transfer pattern to be obtained.

On the other hand, if the heating temperature at the time of transfer is below the shape-retaining temperature of the substrate material, a sufficient groove depth will be impossible to achieve because deformation will not occur at the surface of the disk substrate 1 due to pattern transfer. Moreover, the transferred pattern will have a low strength and damage such as deformation or collapse will tend to arise. By contrast, when the heating temperature at the time of transfer is at or above the melting point, the surface of the disk substrate 1 will melt and deform, disrupting the crystal orientation of the magnetic recording layer 2 and ultimately resulting in deterioration of the magnetic characteristics. Moreover, problems such as peeling or cracking of the magnetic recording layer 2 will tend to arise due to the difference between the coefficients of thermal expansion for the disk substrate 1 and the magnetic recording layer 2.

In the practice of the invention, following fabrication of the workpiece 1a by forming a magnetic recording layer 2 on the disk substrate 1 then forming a protective layer 3 on the magnetic recording layer 2, a transfer step with the above-described stamper 11 is carried out.

To carry out the transfer step following formation of the protective layer 3 on the magnetic recording layer 2, it is necessary to prevent the surface of the magnetic recording layer 2 from deteriorating due to contact with the atmosphere or the like. Moreover, the protective layer 3 is more resistant to plastic deformation than the magnetic recording layer 2, and thus tends to remain at the bottom 5a of the grooves 5. Consequently, because there is thus no need to provide a protective layer 3 forming step following the transfer step, the manufacturing operations can be simplified, enabling the manufacture of a magnetic recording medium having a high weatherability.

In the practice of the invention, films such as the magnetic recording layer 2 expelled by plastic deformation remain on the sidewalls of the groove, but because the magnetic anisotropy shifts from the direction perpendicular to the substrate, it has substantially no influence on data read and write.

In the practice of the invention, it is also possible to form the protective layer 3 on the magnetic recording layer 2 after the transfer step using the above-described stamper 11.

In such a case, when the transfer step is carried out before forming the protective layer 3, because a protective layer 3 having a high hardness is not present on the surface of the magnetic recording layer 2, plastic deformation of the magnetic recording layer 2 by the stamper 11 can be stably carried out. On the other hand, given the possibility that the surface of the magnetic recording layer 2 may come into contact with the atmosphere and thus deteriorate, it is preferable to carry out such a transfer step in an inert gas atmosphere.

In addition, in the practice of the invention, following the transfer step with the above-described stamper 11, a protective layer 3 may again be formed on the surface of the workpiece 1a.

In this case, by once again covering with a protective layer 3 the groove from which the magnetic recording layer 2 and the protective layer 3 have been expelled in the above-described transfer step, it is possible to prevent corrosion and a deterioration in the magnetic characteristics due to oxidation and the like from the sidewalls of the groove 5. If such a protective layer 3 is again formed, it is preferable for the layer to be a diamond-like carbon (DLC) film having excellent weatherability and wear resistance. Such a film has a thickness of preferably 5 nm or less.

Depending on the material of which the protective layer 3 is made and the mechanical properties of the film, there will be cases in which the protective layer 3 in the grooves 5 remains without being expelled in the transfer step, enabling sufficient weatherability to be achieved. Whether to re-form the protective layer 3 is thus optional.

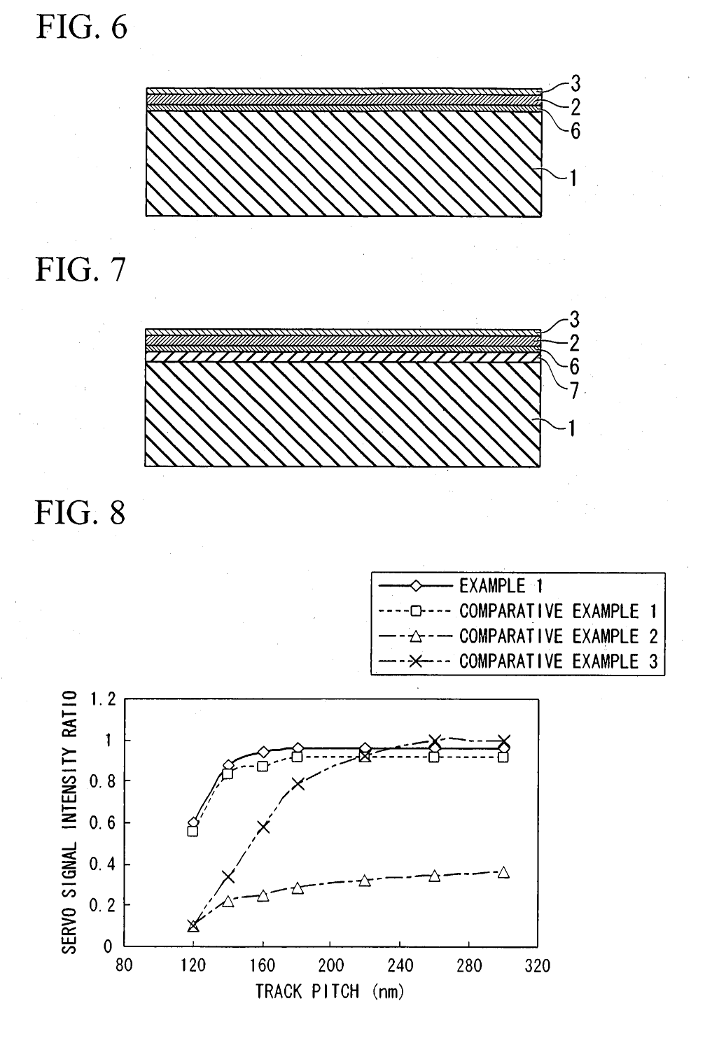

Alternatively, as shown in FIG. 6, the magnetic recording media according to the invention may have a construction in which an orientation layer 6 is disposed between the disk substrate 1 and the magnetic recording layer 2.

The orientation layer 6 is a layer which controls the crystal orientation and grain size in the layer formed directly above it. It has a thickness of preferably about 5 to 30 nm.

It is preferable for the orientation layer 6 to have a hexagonal closest-packed (hcp) structure. This enables good control of the perpendicular orientation and magnetic grain size of the magnetic recording layer 2. Illustrative examples of orientation layers 6 having an hcp structure which may be used include those made of ruthenium or a ruthenium alloy containing, for example, boron, carbon, phosphorus, silicon, aluminum, chromium, cobalt, tantalum, tungsten, praseodymium, neodymium or samarium.

Alternatively, the orientation layer 6 may be built up in layers from materials having different compositions or structures. For example, use may be made of a first orientation layer having a face-centered cubic (fcc) structure on which has been deposited a second orientation layer having a hcp structure. In this way, the orientability of the magnetic recording layer 2 can be increased, suppressing the crystal grain size to be enlarged. Illustrative examples of orientation layers 6 having a fcc structure that may be used include platinum and platinum alloys containing, for example, boron, carbon, phosphorus, silicon, aluminum, chromium, cobalt, tantalum, tungsten, praseodymium, neodymium or samarium; palladium and palladium alloys containing, for example, boron, carbon, phosphorus, silicon, aluminum, chromium, cobalt, tantalum, tungsten, praseodymium, neodymium or samarium; and NiFe alloys such as NiFe and NiFeW.

Alternatively, the magnetic recording media according to the invention may have, as shown in FIG. 7, an arrangement in which a soft magnetic layer 7 is disposed between the disk substrate 1 and the orientation layer 6.

The soft magnetic layer 7 serves to increase the perpendicular component of the magnetic flux generated from the magnetic head and to more robustly fix in the perpendicular direction the direction of magnetization of the magnetic recording layer 2 on which data is to be recorded.

A soft magnetic material containing iron, nickel or cobalt may be used as the soft magnetic layer 7. Illustrative examples of such soft magnetic materials include FeCo, FeCo alloys such as FeCoB and FeCoAl, FeNi, FeNi alloys such as FeNiMo, FeNiCr, FeNiSi and FeNiB, FeAl, FeAl alloys such as FeAlSi, FeAlSiCr and FeAlO, FeCr, FeCr alloys such as FeCrTi and FeCrCu, FeTa, FeTa alloys such as FeTaC and FeTaN, FeMg alloys such as FeMgO, FeZr, FeZr alloys such as FeZrN, FeC alloys, FeN alloys, FeSi alloys, FeP alloys, FeNb alloys, FeHf, FeHf alloys such as FeHfN, FeB, FeB alloys such as FeBCr, CoB alloys, CoP alloys, CoNi, CoNi alloys such as CoNiB and CoNiP, NiP alloys, and FeCoNi, FeCoNi alloys such as FeCoNiP and FeCoNiB. In addition, the above-described soft magnetic material may be a material having a granular structure dispersed in an oxide matrix such as Al₂O₃, ZrO₂, SiO₂, Ta₂O₅ and TiO₂.

Alternatively, the soft magnetic layer 7 may be formed as successive layers of soft magnetic materials having different compositions or may be formed as successive layers of a soft magnetic material and a nonmagnetic material. In particular, when the soft magnetic layer 7 is given a structure having a ruthenium thin-film formed between layers of a soft magnetic material, generation of the magnetic domain walls distinctive to soft magnetism is suppressed, enabling the suppression of spike noise.

### Magnetic Read/Write Device

Next, the magnetic read/write device according to the invention is described.

The magnetic read/write device of the invention is composed of mainly the above-described magnetic recording medium, a motor, a hub, a servo mechanism, a magnetic head and a controller. A ring-type head or a single-pole head may be used as the magnetic head, provided it is adapted for reading to and writing from a perpendicular system.

In this magnetic read/write device, by using the above-described magnetic recording medium of the invention, the influence of noise and fringing that arise at the edges of the magnetic tracks 3 can be reduced, enabling the track density to be improved. Moreover, because the radially adjoining magnetic tracks 4 are magnetically separated from one another by grooves 4, this eases the constraints on the magnetic head writing width. Also, the servo signals are provided beforehand to the magnetic recording medium, making it possible to exclude servo writing, thus enabling lower cost manufacture. In this way, a low-cost magnetic read/write device suitable for high-density recording can be achieved.

### EXAMPLES

Examples are given below to illustrative the advantageous effects of the invention, although it should be understood that the following examples are not limitative of the invention.

### Example 1

In Example 1, a substrate made of polycarbonate (outside diameter, 48 mm; thickness, 0.508 mm; inside diameter, 15 mm) was furnished and the surface was cleaned then vacuum dried in an oven (100° C., 1 mmHg (=133.322 Pa), 1 hour).

Next, the substrate was placed in the film-forming chamber of a DC magnetron sputtering system (C-3010, manufactured by Anelva Corporation), and the interior of the chamber was evacuated to an ultimate vacuum of 1×10⁻⁵ Pa. A 80 nm thick soft magnetic layer was formed on this substrate by sputtering using a 89Co-4Zr-7Nb (cobalt content, 89 at %; zirconium content, 4 at %; niobium content, 7 at %) target, a 3 nm thick first orientation layer was formed on the soft magnetic layer using a platinum target, a 12 nm thick second orientation layer was formed on the first orientation layer using a ruthenium target, a 12 nm thick magnetic layer was formed on the second orientation layer using a 65Co-10Cr-15Pt-10SiO₂ (cobalt content, 65 mol %; chromium content, 10 mol %; platinum content, 15 mol %; SiO₂ content, 10 mol %) target, and a 4 nm thick protective layer made of carbon was formed on the latter magnetic layer, thereby fabricating a workpiece.

Next, the workpiece was set on the susceptor in an imprinter and a nickel electroformed stamper connected to the end of a pressurizing piston was pressed against the workpiece, thereby transferring by imprinting the track pattern (track pitch, 180 nm; track width, 80 nm; groove depth, 80 nm) and the servo data pattern to the workpiece.

The stamper had, on the face thereof which came into contact with the workpiece, protrusions corresponding to the shape to be actually transferred to the workpiece. These protrusions, which act as a negative pattern, had at the ends thereof a curved surface which was rounded and had a radius of curvature of 80 nm. The radius of curvature R of the curved surface on the protrusions of the stamper and the width W of the protrusions were measured using an atomic force microscope (AFM) manufactured by Digital Instrument. At the time of transfer, the susceptor and stamper were heated to and held at 150° C. Pressurization to a pressure of 35 kgf/cm² (=343 N/cm²) was carried out.

The stamper was then separated from the workpiece, following which the workpiece was placed in the film-forming chamber of a DC magnetron sputtering system (C-3010, manufactured by Anelva Corporation) and the interior of the chamber was evacuated to an ultimate vacuum of 1×10⁻⁵ Pa. Next, using ethylene gas as the starting material and a 13.5 MHz radio-frequency power supply, a 3 nm protective layer made of diamond-like carbon was formed by chemical vapor deposition. Finally, a lubricating layer of perfluoroether was formed to a thickness of 2 nm on the protective layer, thereby completing the manufacture of a magnetic recording medium according to Example 1. The radius of curvature R′ at the bottom of the grooves in this magnetic recording medium and the width W′ of the grooves were measured using an atomic force microscope manufactured by Digital Instrument.

The magnetic recording medium of Example 1 was incorporated into a magnetic read/write device and data read and write were carried out, as a result of which the magnetic head positioning operations and data read/write operations were confirmed to be appropriate.

A giant magnetoresistive (GMR) device was used as the magnetic head on the read side, and a single-pole type GMR head was used on the write side. The head positioning signals were observed with an oscilloscope. The read/write characteristics were evaluated at a linear recording density of 960 kFCI, and an error rate of 1×10^{-5.7} was obtained.

### Example 2

In Example 2, aside from using reinforced glass (N5 glass produced by Hoya) as the substrate, setting the temperature during imprinting to 360° C., and setting the pressure in an argon atmosphere to 2,000 kgf/cm² (=19,613 N/cm²), a magnetic recording medium according to Example 2 was manufactured by the same method as in Example 1.

Next, the magnetic recording medium of Example 2 was incorporated into a magnetic read/write device, and data read and write were carried out, as a result of which the magnetic head positioning operations and data read/write operations were confirmed to be appropriate.

A GMR head which used a GMR device for the read side and made the write side single-pole type was used as the magnetic head. The head positioning signals were observed with an oscilloscope. The read/write characteristics were evaluated at a linear recording density of 960 kFCI, and an error rate of 1×10^{-5.5} was obtained.

### Example 3

In Example 3, aside from using an aluminum substrate having formed thereon an NiP plating layer and setting the temperature during imprinting to 300° C., a magnetic recording medium according to Example 3 was manufactured by the same method as in Example 1.

Next, the magnetic recording medium of Example 3 was incorporated into a magnetic read/write device, and data read and write were carried out, as a result of which the magnetic head positioning operations and data read/write operations were confirmed to be appropriate.

A GMR head which used a GMR device for the read side and made the write side single-pole type was used as the magnetic head. The head positioning signals were observed with an oscilloscope. The read/write characteristics were evaluated at a linear recording density of 960 kFCI, and an error rate of 1×10^{-5.3} was obtained.

### Comparative Example 1

In Comparative Example 1, a substrate made of polycarbonate (outside diameter, 48 mm; thickness, 0.508 mm; inside diameter, 15 mm) was furnished and the surface was cleaned then vacuum dried in an oven (100° C., 1 mmHg (=133.322 Pa), 1 hour).

Next, the substrate was placed in the film-forming chamber of a DC magnetron sputtering system (C-3010, manufactured by Anelva Corporation), and the interior of the chamber was evacuated to an ultimate vacuum of 1×10⁻⁵ Pa. A 80 nm thick soft magnetic layer was formed on this substrate by sputtering using a 89Co-4Zr-7Nb (cobalt content, 89 at %; zirconium content, 4 at %; niobium content, 7 at %) target, a 3 nm thick first orientation layer was formed on the soft magnetic layer using a platinum target, a 12 nm thick second orientation layer was formed on the first orientation layer using a ruthenium target, a 12 nm thick magnetic layer was formed on the second orientation layer using a 65Co-10Cr-15Pt-10SiO₂ (cobalt content, 65 mol %; chromium content, 10 mol %; platinum content, 15 mol %; SiO₂ content, 10 mol %) target, and a 4 nm thick protective layer made of carbon was formed on the latter magnetic layer, thereby fabricating a workpiece.

Next, a thermoset resist was applied to the protective layer by dipping, forming a resist layer. The workpiece was then set on the susceptor in an imprinter and a nickel electroformed stamper connected to the end of a pressurizing piston was pressed against the workpiece, thereby transferring by imprinting a track pattern and servo data pattern to the workpiece.

The workpiece was then baked at a temperature of 150° C. for 10 minutes to cure the resist layer.

Next, the workpiece was set in a vacuum system and the resist layer remaining in recessed areas of the pattern was removed by ion beam etching using argon gas, following which the gas was replaced with SF₆ and the protective layer, magnetic layer and orientation layer in the recessed areas was removed by reactive etching.

The resist layer was then removed from the surface of the workpiece, following which the workpiece was placed in the film-forming chamber of a DC magnetron sputtering system (C-3010, manufactured by Anelva Corporation) and the interior of the chamber was evacuated to an ultimate vacuum of 1×10⁻⁵ Pa. Next, using ethylene gas as the starting material and a 13.5 MHz radio-frequency power supply, a 3 nm protective layer made of diamond-like carbon was formed by chemical vapor deposition. Finally, a lubricating layer of perfluoroether was formed to a thickness of 2 nm on the protective layer, thereby completing the manufacture of a magnetic recording medium according to Comparative Example 1. The track pattern on the magnetic recording medium in Comparative Example 1 had a track pitch of 180 nm, a track width of 100 nm, and a groove depth of 30 nm.

The magnetic recording medium of Comparative Example 1 was incorporated into a magnetic read/write device and data read and write were carried out, as a result of which the magnetic head positioning operations and data read/write operations were confirmed to be appropriate.

A GMR head which used a GMR device for the read side and made the write side single-pole type was used as the magnetic head. The head positioning signals were observed with an oscilloscope. The read/write characteristics were evaluated at a linear recording density of 960 kFCI, and an error rate of 1×10^{-4.8} was obtained.

### Comparative Example 2

In Comparative Example 2, a substrate made of polycarbonate (outside diameter, 48 mm; thickness, 0.508 mm; inside diameter, 15 mm) was furnished and a stamper was pressed against one surface of the substrate so as to imprint and thereby transfer the track pattern and servo data. The surface of this substrate was then cleaned, after which it was vacuum dried in an oven (100° C., 1 mm-Hg (=133.322 Pa), 1 hour).

Next, the substrate was placed in the film-forming chamber of a DC magnetron sputtering system (C-3010, manufactured by Anelva Corporation), and the interior of the chamber was evacuated to an ultimate vacuum of 1×10⁻⁵ Pa). A 80 nm thick soft magnetic layer was formed on this substrate by sputtering using a 89Co-4Zr-7Nb (cobalt content, 89 at %; zirconium content, 4 at %; niobium content, 7 at %) target, a 3 nm thick first orientation layer was formed on the soft magnetic layer using a platinum target, a 12 nm thick second orientation layer was formed on the first orientation layer using a ruthenium target, a 12 nm thick magnetic layer was formed on the second orientation layer using a 65Co-10Cr-15Pt-10SiO₂ (cobalt content, 65 mol %; chromium content, 10 mol %; platinum content, 15 mol %; SiO₂ content, 10 mol %) target, a 4 nm thick protective layer made of carbon was formed on the latter magnetic layer, and finally a 2 nm thick lubricating layer of perfluoroether was formed on the protective layer.

The resulting medium was introduced into a servo write device and the servo regions were DC formatted by a strong writing current using a magnetic head, following which the magnetization was reversed in only the raised areas by a weak writing current, thereby manufacturing a magnetic recording medium according to Comparative Example 2. The tracks written onto the magnetic recording medium of Comparative Example 2 had a track pitch of 180 nm, a track width of 80 nm, and a groove depth of 80 nm.

The magnetic recording medium of Comparative Example 2 was introduced into the magnetic read/write device, and data reading and writing was carried out.

A GMR head which used a GMR device for the read side and made the write side single-pole type was used as the magnetic head. The head positioning signals were observed with an oscilloscope. A signal strength and a signal-to-noise ratio sufficient for positioning the head were not obtained, as a result of which it was not possible to properly carry out the head positioning operation. The read/write characteristics were evaluated at a linear recording density of 960 kFCI, and an error rate of 1×10^{-2.3} was obtained. The track waveform was examined with an oscilloscope, whereupon the data waveform was observed to have an irregular amplitude. Moreover, head positioning was poor, as a result of which the data read/write operations were found to be unstable.

### Comparative Example 3

In Comparative Example 3, a substrate made of polycarbonate (outside diameter, 48 mm; thickness, 0.508 mm; inside diameter, 15 mm) was furnished and the surface was cleaned then vacuum dried in an oven (100° C., 1 mmHg (=133.322 Pa), 1 hour).

Next, the substrate was placed in the film-forming chamber of a DC magnetron sputtering system (C-3010, manufactured by Anelva Corporation), and the interior of the chamber was evacuated to an ultimate vacuum of 1×10⁵ Pa. A 80 nm thick soft magnetic layer was formed on this substrate by sputtering using a 89Co-4Zr-7Nb (cobalt content, 89 at %; zirconium content, 4 at %; niobium content, 7 at %) target, a 3 nm thick first orientation layer was formed on the soft magnetic layer using a platinum target, a 12 nm thick second orientation layer was formed on the first orientation layer using a ruthenium target, a 12 nm thick magnetic layer was formed on the second orientation layer using a 65Co-10Cr-15Pt-10SiO₂ (cobalt content, 65 mol %; chromium content, 10 mol %; platinum content, 15 mol %; SiO₂ content, 10 mol %) target, a 4 nm thick protective layer made of carbon was formed on the latter magnetic layer, and a 2 nm thick lubricating layer of perfluoroether was formed on the protective layer.

The resulting medium was introduced into a servo writing device and, by using a special-purpose head to write predetermined signals such as servo signals, a magnetic recording medium according to Comparative Example 3 was manufactured. The track pattern formed on the magnetic recording medium of Comparative Example 3 had a track pitch of 180 nm and a track width of 100 nm.

The magnetic recording medium of Comparative Example 3 was incorporated into a magnetic read/write device, and data read and write were carried out. As a result, the magnetic head positioning operations and data read/write operations were confirmed to be appropriate.

A GMR head which used a GMR device for the read side and made the write side single-pole type was used as the magnetic head. The head positioning signals were observed with an oscilloscope. The read/write characteristics were evaluated at a linear recording density of 960 kFCI, and an error rate of 1×10^{-4.2} was obtained.

Table 1 below shows the results of head positioning and read/write characteristic (error rate) evaluations for Example 1 and for Comparative Examples 1 to 3. In Table 1, “Good” indicates that head positioning was good, and “NG” indicates that head positioning was poor.

TABLE 1

| | | Error rate |
|---|---|---|
| | Head positioning | (Log X) |
| Example 1 | Good | −5.7 |
| Comparative Example | Good | −4.8 |
| Comparative Example | NG | −2.3 |
| Comparative Example | Good | −4.2 |

As is apparent from the results shown in Table 1, in Example 1, head positioning could be carried out and the error rate was better than in Comparative Examples 1 to 3. Specifically, unlike in Comparative Example 1, deterioration in the magnetic characteristics due to shaping of the magnetic layer did not arise in Example 1, enabling a better error rate to be achieved than in Comparative Example 1. Moreover, the head position was better in Example 1 than in Comparative Example 2, enabling the precision of error rate measurement to be improved. Also, less noise arose at the track edges in Example 1 than in Comparative Example 3, enabling a better error rate to be achieved.

Next, samples having different track pitches were manufactured for Example 1 and Comparative Examples 1 to 3, and the servo signal intensity ratios were compared. The results are shown in FIG. 8. The servo signal intensity ratios shown in FIG. 8 are normalized values based on a value of 1 for a medium having a track pitch of 260 nm manufactured by the method of Comparative Example 3.

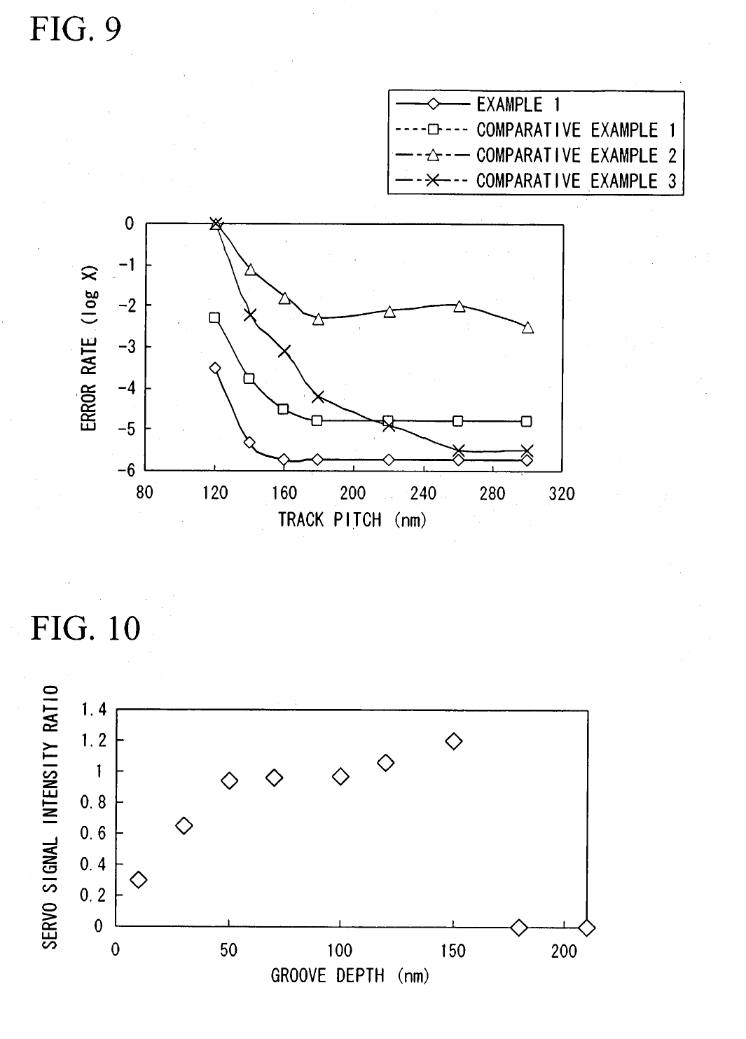

Samples having different track pitches were manufactured for Example 1 and Comparative Examples 1 to 3. The error rates are compared in FIG. 9.

As is evident from the results shown in FIGS. 8 and 9, in Example 1, good servo signal strength rates were obtained even at a track pitch below 180 nm, and only minor deterioration in the error rate occurred even at a track pitch of 160 nm.

Next, in Example 1 and Comparative Examples 1 and 2, the throughput was computed based on the data obtained when 5,000 magnetic recording disks of each type were manufactured. The throughput was determined for the operations from substrate fabrication (cleaning or molding) to application of the lubricating layer, and up to formatting of the servo regions. The throughputs for Example 1 according to the invention and Comparative Examples 1 and 2 are shown in Table 2 below.

TABLE 2

| | Throughput (pph) |
|---|---|
| Example 1 | 457 |
| Comparative Example 1 | 138 |
| Comparative Example 2 | 345 |

It is apparent from the results in Table 2 that the productivity in Example 1 of the invention was better than the productivity in Comparative Examples 1 and 2. In Comparative Example 1, shaping the magnetic layer took time, making it impossible to achieve a good throughput. In Comparative Example 2, following production of the medium, the servo region had to be formatted (magnetization in the opposite directions in raised and recessed areas), thus lowering the throughput.

Next, in Example 1, media having different groove depths (height difference between raised and recessed areas) were produced, and the resulting servo signal intensity ratios are compared in FIG. 10. The servo signal intensity ratios shown in FIG. 10 are normalized values based on a value of 1 for a medium having a track pitch of 260 nm manufactured by the method of Comparative Example 3.

From the results shown in FIG. 10, a good servo signal intensity ratio can be obtained at a groove depth in a range of 10 to 100 nm, although a range of 50 to 100 nm is more preferred. At a groove depth of less than 10 nm, the servo signal intensity weakens considerably. On the other hand, at more than 100 nm, the servo signal intensity increases, but the amplitude of the signal strength per track becomes larger. At 150 nm, precise measurement of the signals was impossible. Moreover, at above 180 nm, obtaining signals per se became impossible due to contact between the head and the medium. This appears to be due to a decline in the flying height by the head in the servo region, and thus a loss of flying stability. Hence, by setting the groove depth to 100 nm or below, the head flying stability can be ensured.

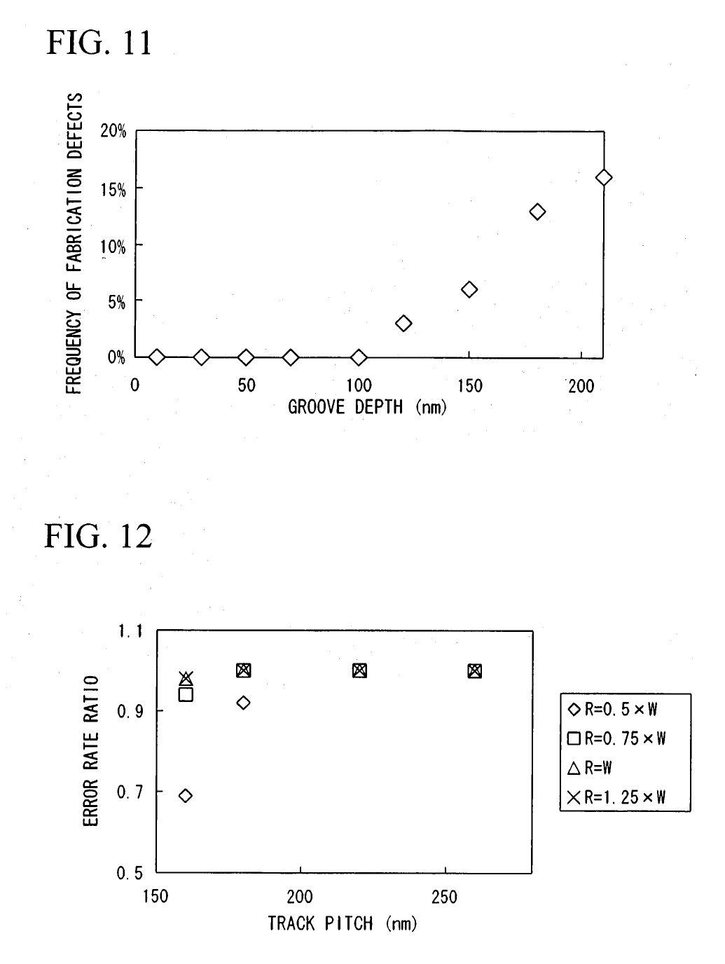

Next, media having different grooves depths were manufactured for Example 1 according to the invention, and the results obtained from measurements of the ease of medium fabrication are shown in FIG. 11. FIG. 11 shows the proportion of disks which had damaged areas in the pattern out of 100 magnetic recording disks manufactured according to Example 1. It is apparent from the results shown in FIG. 11 that the incidence of pattern fabrication defects increases at groove depths above 100 nm.

Next, FIG. 12 shows the error rates for magnetic recording media manufactured by the method of Example 1 using stampers having different degrees of roundness at the tip of the protrusions and at different track pitches. The error rate ratios shown in FIG. 12 were obtained as follows. The error rate when data was recorded to a given track at a density of 960 kFCI was used as the baseline. Next, data was similarly written to a radially adjoining track, following which the error rate of the given track was measured. The ratio of the latter error rate to the baseline error rate prior to the recording of data to the adjoining track was then determined.

From the measured results shown in FIG. 12, it is apparent that when the protrusions on the stamper have tips with a curved surface such that 0.75 W≦R, where R is the radius of curvature of the curved surface and W is the width of the protrusion, deterioration in the error rate due to data recording to the adjoining track is low. On the other hand, when 0.75 W>R, at a narrowed track pitch, a marked deterioration occurs in the error rate due to fringing when data is recorded to the adjoining track.

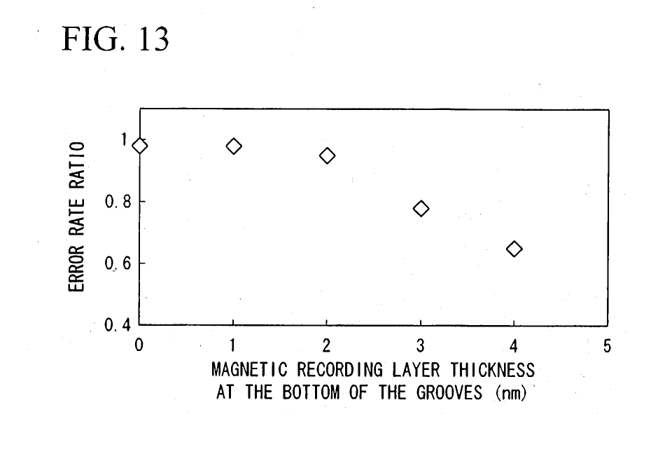

Next, FIG. 13 shows the results obtained from measurements of the error rates for media having differing magnetic recording layer 2 thicknesses (residual thicknesses) at the bottom 5a of the grooves were manufactured. The track pitch was set at 160 nm, and the height difference between the raised and recessed features was set at 80 nm. The thickness of the magnetic recording layer 2 at the bottom 5a of the grooves was varied by changing the degree of roundness at the tips of the protrusions on the stamper.

The error rate ratios shown in FIG. 13 were obtained as follows. The error rate when data was recorded to a given track at a density of 960 kFCI was used as the baseline. Next, data was similarly written to a radially adjoining track, following which the error rate of the given track was measured. The ratio of the latter error rate to the baseline error rate prior to the recording of data to the adjoining track was then determined.

The thickness of the magnetic recording layer 2 at the bottom 5a of the grooves 5 was measured by cross-sectional transmission electron microscopy (TEM), and the measurements indicated as the average thickness of the magnetic recording layer 2 remaining at the bottom 5a of the grooves.

It is apparent from the results shown in FIG. 13 that, by setting the thickness of the magnetic recording layer 2 at the bottom 5a of the grooves 5 to 2 nm or less, and preferably 1 nm or less, deterioration in the error rate due to fringing decreases. On the other hand, when a magnetic layer thicker than 2 nm remained at the bottom of the grooves, deterioration in the error rate due to fringing arose.

Next, Table 3 shows the results of measurements on the life of the stamper. Table 3 shows the number of disks that had been manufactured by the time that the shape of the recessed areas in the pattern formed on the magnetic recording media manufactured using the same stamper exhibited 10% deformation from the initial shape. The upper limit in the number of disks manufactured was set at 5,000. Places in the table lacking numerical entries signify that a deterioration in shape was not observed.

TABLE 3

| The width of the protrusions versus radius | |
|---|---|
| of curvature of the curved surface (R/W) | Number of disks |
| 0.5 | — |
| 0.75 | — |
| 1 | — |
| 1.25 | 4350 |
| 1.4 | 1300 |

From the results shown in Table 3, it is apparent that the stamper has an acceptable long life when R≦1.25 W, where R is the radius of curvature at the curved surface of the raised features, and W is the width of the raised features. On the other hand, when R>1.25 W, the life of the stamper decreases due to a deterioration in the tip shape.

### INDUSTRIAL APPLICABILITY

The invention enables higher density magnetic tracks to be formed without resorting to complex, difficult-to-control microfabrication techniques such as dry etching, thus making it possible to easily and inexpensively manufacture discrete track-type magnetic recording media having excellent magnetic characteristics suitable for higher recording densities.

1. A method of manufacturing magnetic recording media having a main surface on which magnetic tracks are disposed in a substantially concentric arrangement and on which grooves for magnetically separating radially adjoining magnetic tracks from one another are formed,
the method being characterized by forming on a flat substrate at least a magnetic recording layer so as to fabricate a workpiece, then pressing a stamper having protrusions corresponding to the grooves against a main surface of the workpiece so as to transfer the shape of the protrusions to the workpiece and form grooves between the magnetic tracks.

2. The method of manufacturing magnetic recording media according to claim 1 which is characterized in that the protrusions have a tip with a curved surface which satisfies the relationship 0.75 W≦R≦1.25 W, where R is the radius of curvature of the curved surface and W is the width of the protrusions.

3. The method of manufacturing magnetic recording media according to claim 1 which is characterized in that the grooves have a depth of from 50 to 100 nm.

4. The method of manufacturing magnetic recording media according to claim 1 which is characterized by fabricating a workpiece in which the magnetic recording layer is formed on the substrate and a protective layer is formed on the magnetic recording layer, then pressing the stamper against the main surface of the workpiece.

5. The method of manufacturing magnetic recording media according to claim 1 which is characterized by pressing the stamper against the main surface of the workpiece, then forming a protective layer on the magnetic recording layer.

6. The method of manufacturing magnetic recording media according to claim 1 which is characterized by pressing the stamper against the workpiece until the shape of the protrusions is transferred to the substrate.

7. The method of manufacturing magnetic recording media according to claim 1 which is characterized by pressing the stamper against the workpiece until the thickness of the magnetic recording layer becomes thinner at the bottom of the grooves.

8. The method of manufacturing magnetic recording media according to claim 1 which is characterized by pressing the stamper against the workpiece until the magnetic recording layer is severed at the bottom of the grooves.

9. The method of manufacturing magnetic recording media according to claim 1 which is characterized in that the magnetic recording layer has perpendicular magnetic anisotropy.

10. The method of manufacturing magnetic recording media according to claim 1 which is characterized by placing an orientation layer between the substrate and the magnetic recording layer.

11. The method of manufacturing magnetic recording media according to claim 10 which is characterized by placing a soft magnetic layer between the substrate and the orientation layer.

12. The method of manufacturing magnetic recording media according to claim 1 which is characterized in that the substrate is made of a material selected from among plastic, glass, and aluminum alloy.

13. A magnetic recording medium having a main surface on which magnetic tracks are disposed in a substantially concentric arrangement and on which grooves for magnetically separating radially adjoining magnetic tracks from one another are formed,
the medium being characterized in that a substrate in which grooves have been formed has formed thereon at least a magnetic recording layer and, over the magnetic recording layer, a protective layer, and the magnetic recording layer has a smaller thickness or is severed at the bottom of the grooves.

14. The magnetic recording medium of claim 13 which is characterized in that the bottom of the grooves has a curved surface which satisfies the relationship 0.75 W′≦R′≦1.25 W′, where R′ is the radius of curvature of the curved surface and W′ is the width of the grooves.

15. The magnetic recording medium of claim 13, wherein the magnetic recording layer at the bottom of the grooves has a thickness of 2 nm or less.

16. A magnetic read/write device comprising a magnetic recording medium and a magnetic head which writes magnetic signals to and reads magnetic signals from the magnetic recording medium,
the magnetic read/write device being characterized in that the magnetic head is a single-pole magnetic head and the magnetic recording medium is the magnetic recording medium of claim 13.
